(19) United States
(12) Patent Application Publication
(10) Pub. No.: US 2002/0177403 A1
(43) Pub. Date: Nov. 28, 2002

(54) High availability broadband communications satellite system using satellite constellations in elliptical orbits inclined to the equatorial plane

(76) Inventors: James Nicholas LaPrade, Pleasanton, CA (US); Andrew E. Turner, Mountain View, CA (US); Brian R. Kemper, Sunnyvale, CA (US)

Correspondence Address: PERMAN & GREEN, 425 POST ROAD, FAIRFIELD, CT, 06430, US

(21) Appl. No.: 10/073,699

(22) Filed: Feb. 11, 2002

Related U.S. Application Data
(60) Provisional application No. 60/267,580, filed on Feb. 9, 2001.

(51) Int. Cl. H04B 7/185

(52) U.S. Cl. 455/12.1; 455/13.1; 455/13.2; 455/427

(57) ABSTRACT

A broadband communication system having a first broadband communication ground station, a second broadband communication ground station, and a satellite constellation. The satellite constellation is used for conducting bi-direction broadband communication between the first broadband communication ground station and the second broadband communication ground station. At least one satellite of the satellite constellation has an inclined eccentric orbit in a first orbit plane. The satellite constellation is disposed in orbit so that when observed from a predetermined ground observation point a number of satellites, including the at least one satellite, in the constellation appear to follow a substantially common path which extends through a predetermined active zone. The number of satellites moving along the common path is such that the predetermined active zone has one satellite from the number of satellites continuously located therein. The at least one satellite, and at least another satellite from the number of satellites are launched into a common initial orbit plane which is different than the first orbit plane.

### CROSS-REFERENCE TO RELATED APPLICATION

This application claims the benefit of U.S. Provisional Application No. 60/267,580, filed Feb. 9, 2001, which is incorporated by reference herein in its entirety.

### BACKGROUND OF THE INVENTION

1. Field of the Invention

The present invention relates to satellite communication systems and, more particularly, to the construction and operation of satellite constellations providing high availability of broadband satellite communications where the satellites are in elliptical orbits inclined to the equatorial plane.

2. Prior Art

Most of the worlds land mass, population, wealth, industry, military assets, and operating areas are located in the Northern Hemisphere. For this reason it is desirable to provide continuous hemispheric coverage such that at least one satellite will be in view at any time from any one location in a specified region in the Northern Hemisphere. Most present day constellations used to achieve this continuous coverage are based on satellites in circular geo-synchronous orbits where the satellites appear to be stationary over an equatorial area. Since the circular geo-synchronous equatorial satellite is stationary with respect to the Earth, ground stations for communicating the satellite may be constructed without expensive tracking mechanisms which may include labor intensive maintenance requirements. However, the sections of the equatorial orbit servicing North America, Europe, and Asia is limited as to the number of satellites that may be accommodated. Moreover, as more and more satellites are positioned closer together within these available sections the interference between satellites increases. To alleviate some of this congestion and interference the U.S. Federal Communications Commission (FCC) adopted a policy in 1983 where satellites operating in the 6/4 GHZ band could not be positioned closer than 2° and no closer than 1.5° for satellites operating in the 14/12 GHZ band.

In addition, the geosynchronous orbit of the satellite above the equator requires that users in much of the Northern Hemisphere direct their antenna dish toward a spot low in the southern skies. This arrangement requires that the signal from the satellite to the users ground dish have a longer path length through the Earth's atmosphere, thus increasing the percentage of power lost due to environmental conditions such as atmospheric absorption, absorption by thick fog, and absorption by heavy rain. Furthermore, the user must be able to position the satellite dish such that the dish has a clear and unobstructed view of the satellite. This is not always economically possible for today's consumer of broadband services, such as a person living in a building or an apartment unit within a building that is without a southern exposure.

Lastly, points on the Earth's surface, such as Tokyo and New York City, are too far apart in longitude for a single geosynchronous equatorial satellite to service both simultaneously for services such as single hop telephone service. Communication satellites have been placed in inclined eccentric orbits, such as the Molniya and Tundra orbits, to provide improved coverage over the northern hemisphere. The 24-hour period Tundra orbit, with moderate eccentricity and inclination, was first used by a satellite built by Space Systems/Loral (SS/L) for Sirius Corporation and launched from Baykonur on a Proton launch vehicle in June 2000. Three such spacecraft are currently on orbit to support commercial high-quality digital audio broadcast to small receivers, including specially equipped low-cost car radios, across the United States.

### SUMMARY OF THE INVENTION

In accordance with one aspect of the preferred embodiment, a broadband communication system is provided. The system comprises a first broadband communication ground station, a second broadband communication ground station, and a satellite constellation for conducting bi-directional broadband communication between the first broadband communication ground station and the second broadband communication ground station. The satellite constellation includes at least one satellite having an inclined eccentric orbit in a first orbit plane. The satellite constellation is disposed in orbit so that when observed from a predetermined ground observation point a number of satellites, including the at least one satellite, in the satellite constellation appear to follow a substantially common path which extends through a predetermined active zone. The number of satellites moving along the common path is such that the predetermined active zone has one satellite from the number of satellites continuously located therein. The at least one satellite and at least another satellite from the number of satellites are launched into a common initial orbit plane which is different from the first orbit plane.

### BRIEF DESCRIPTION OF THE DRAWINGS

The foregoing aspects and other features of the present invention are explained in the following description, taken in connection with the accompanying drawings, wherein:

FIG. 1 is a schematic block diagram of a communication system incorporating the features of the present invention in accordance with a first preferred embodiment;

FIG. 1B is a schematic block diagram of a communication system in accordance with another preferred embodiment of the present invention;

FIGS. 2-2A respectively are a schematic block diagram and a perspective view from above the equatorial plane of a representative satellite constellation of the communication system in FIG. 1;

FIG. 3 is a perspective view of an exemplary satellite in the satellite constellation in FIGS. 2-2A;

FIG. 4 is a schematic representation of exemplary Tundra, Molniya, and geosynchronous orbits in the same plane as seen from directly above the plane;

FIG. 4A is a plan view of the ground track of a representative Molniya orbit;

FIGS. 5A-5B are respectively a schematic block diagram showing a portion of the skytrack of satellites in the constellation shown in FIG. 2, and a 360° fish-eye view from the ground of a portion of the sky for satellites at the instant the constellation is shown in FIG. 2A (the center of the figure is the zenith directly overhead and the outermost circle is the horizon. The concentric circles are lines of common elevation.);

FIG. 6 is a graph showing the variation in the argument of perigee (ARGP) of different Tundra orbits having the same inclination and different values of the right ascension of the ascending node (RAAN);

FIG. 7 is a schematic block diagram showing the position of the orbit planes of two satellites from the satellite constellation shown in FIG. 2A;

FIG. 8 is a graph showing a comparison of coverage elevation between Tundra orbit apogee point and GEO spacecraft;

FIG. 9 is a pictorial view from a satellite in the constellation in FIG. 2 orbiting in a 55° inclined Tundra orbit;

FIG. 10 is another 360° fish-eye view from a ground site of a portion of the sky showing representative skytracks for satellites in the constellation in FIG. 2 having different Tundra and Molniya orbits;

FIG. 11 is a graph showing satellite apparent motion as viewed from a ground site over time for satellites in a Tundra and Molniya orbits;

FIG. 12 is a schematic block diagram showing the initial orbit sub-plane for two satellites in the constellation in FIG. 2A launched on a common launcher;

FIG. 13 is a graph showing velocity increment (delta-V) to Tundra orbit with perigee at 30847 km radius and apogee radius 53481 km from two transfer orbit cases involving different perigee raising conditions; and

FIG. 14 is a schematic block diagram of a communication system in accordance with another preferred embodiment of the present invention.

### DETAILED DESCRIPTION OF THE PREFERRED EMBODIMENT

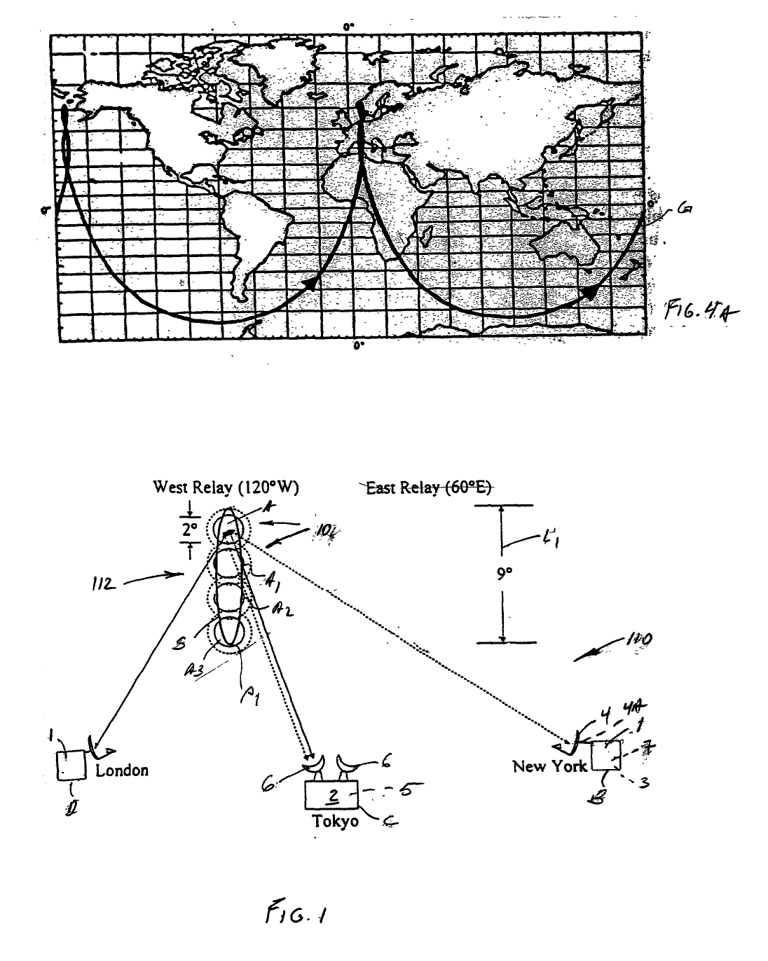

Referring to FIG. 1, there is shown a schematic block diagram of a communication system 110 incorporating features of the present invention. Although the present invention will be described with reference to the single embodiment shown in the drawings, it should be understood that the present invention can be embodied in many alternate forms of embodiments. In addition, any suitable size, shape or type of elements or materials could be used.

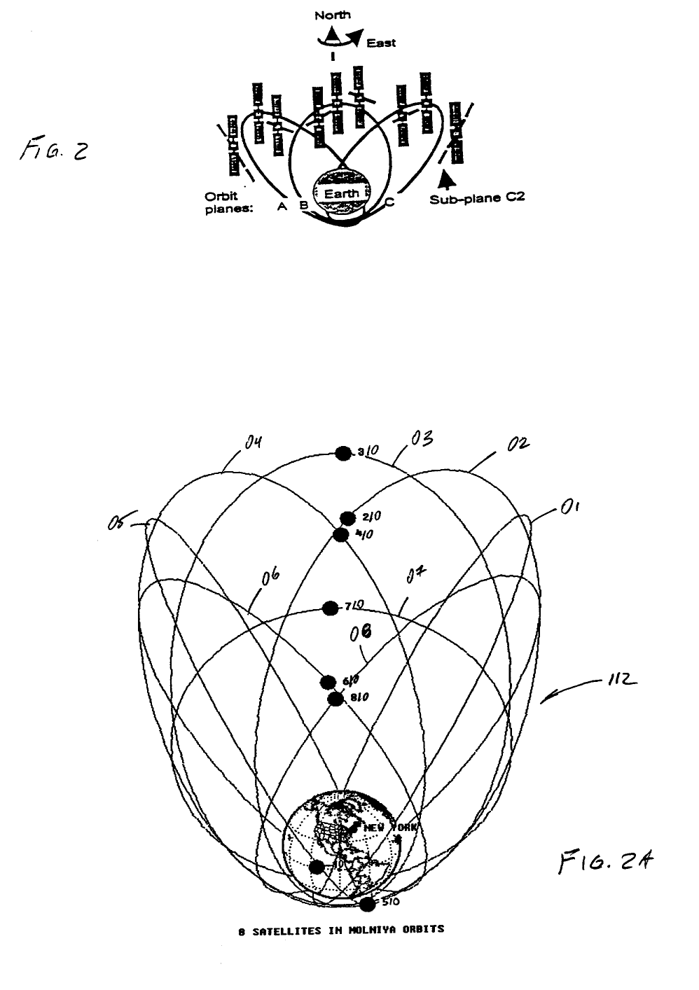

Referring also to FIGS. 2-2A, the broadband communication system 110 generally comprises ground terminals 1, base station 2 and a satellite constellation 112 (only part of the constellation 112 is shown in FIG. 1). FIG. 1 shows two representative ground terminals 1 and one representative base station 2 for example purposes. The present invention is equally applicable to a communication system having any number of terminals and base stations. In FIG. 1, the ground terminals are shown as being fixed terminals, though the ground terminals may be mobile terminals as well. The ground terminals 1 and base station 2 are shown in FIG. 1 as having corresponding locations BDC all in the northern hemisphere. In alternate embodiments, the ground terminals and base station may also be located in the southern hemisphere, although due to the significantly larger land mass which exists in the northern hemisphere the majority of stations and terminals are anticipated to be in the northern hemisphere. The ground terminals 1, are capable of broadband bi-directional communication with each other and with base station 2 and conversely the base station 2 is capable of broadband bi-directional communication with the ground terminals 1. FIG. 2 satellite constellation 112 has satellites 10 used to provide broadband bi-directional communication links between ground terminals and base stations of the communication system which are located “beyond the horizon” relative to each other such as terminals 1 and station 2 in FIG. 1. The satellites 10 in the constellation 112 are disposed in orbit to provide a maximum coverage area for ground terminals and base stations located in the northern hemisphere with a minimum number of satellites. Maximum coverage is provided in the case where ground terminals have fixed antennas with a narrow beam. All satellites in the constellation 112 follow a substantially common path or skytrack S (only a portion of which is shown in FIG. 1) when viewed from the ground. At least one satellite in the constellation is at all times within the beam, or active zone A illuminated by the beam of the antenna on the ground terminals and base stations in the coverage area provided by the communication system 10. This is achieved by having each satellite 10 in the constellation orbit in a different optimal orbital plane arranged to provide optimal coverage with the satellites in adjacent planes having an appropriate phase difference as will be described in greater detail below. The satellites 10 in the constellation may be launched two or more at a time into orbit in an initial orbit plane which is a sub-plane of the optimal orbit planes of the two or more satellites being launched together. The satellites may be maneuvered between the sub-plane and optimal planes using on-board maneuvering thrusters. Back up or spare satellites may be allowed to continue to orbit in the sub-plane. The back up satellites may also be used to provide coverage from its orbit in the sub-plane or may be maneuvered to an optimal plane to replace a failed primary satellite 10 in the optimal plane.

In greater detail now, and with reference still to FIG. 1, the ground terminals 1 generally include a user interface 7, an electronic package 3, and an antenna 4. The user interface 7 may be as of any suitable type allowing a user to interface with the ground terminal. Accordingly, the user interface 7 may include an alpha numeric keypad, display screens, microphone and speakers and any other suitable means which allows a user to interface with the terminal. By way of example, the terminal 1 may be a cell phone, mobile phone, PC or any other suitable communicating device. The electronic package 3 is connected to the user interface 7. The electronics 3 include components such as processors, modulators/demodulators, and suitable transceiver circuitry to convert information or data input through the user interface 7 to form a suitable broadband RF signal such for example a Kₐ band signal for broadcast from the antenna 4. The circuitry in the electronic package 3 is also capable to achieve the reverse and convert RF a received broadband signal to information or data which is disseminated to the user with the user interface 7. The antenna 4 is electronically connected to the electronic package 3 of the terminal 1. In the preferred embodiment the antenna 4 may be fixedly mounted on a suitable support now shown. In this case, the antenna 4 may be oriented at installation so that the antenna beam covers a zone or section of the skytrack of the satellites 10 in the constellation 112 (see also FIG. 5A). This “illuminated” or active zone A (see FIG. 1) may thus remain unchanged during operation or even lifetime of the terminal. Furthermore, the antenna 4 may be a narrow field antenna which generates a narrow circular beam of about 1.3° to about 2.0°. Thus, the active zone A of the skytrack of orbit (e.g. 01-08 in FIG. 2A) is equivalent to the segment of the skytrack or orbit which extends within about a 1.3° to about 2.0° degree conical beam projected from the ground. The antenna of the ground terminal 1 may be pointed advantageously to a position P1 in the sky where the satellites 10 in the constellation 112 are expected to remain a maximum period of time within the active zone as will be described further below. In accordance with another aspect of the preferred embodiment, the antenna 4 of ground terminal 1 may be provided with a switchable feed network 4A enabling the antenna 4 to point to one of four selectable coverage areas A-A3 along a 9° wide section L1 of the sky at a constant longitude.

The base station 2 of the communication system 110 is capable of initiating and conducting broadband bi-directional communication between the ground terminals 1 via satellite 10 in constellation 110. The base station 2 may also be capable of enabling bi-directional communications between the ground terminals 1 or between a ground terminal and one or more other ground communication devices (not shown) (i.e. PCs, landline handsets, cell phones . . . ). As such, the base station 2 may be linked to one or more cell networks, public switched telephone networks (PSTNs) local area networks (LANs) (not shown). The base station preferably includes suitable telephone circuitry to respond to or initiate bi-directional communications with the ground terminals 1. The telephony circuitry is preferably connected to antennas 6 of the base station which respectively transmit and receive uplink and downlink signals from satellites 10 in the constellation. The antennas are preferably pointed to at least one of the active zones A of the skytrack S. In alternate embodiments, the base station 2 may include additional processors and circuitry for receiving satellite ephemeris data and for computing and commanding orbital maneuvers of the satellites 10 in the constellation 112 to maintain optimal coverage. Referring now to FIGS. 2-2A there is shown a feature of the communication system 110 in the preferred embodiment which, as noted before, provides that satellite constellation 112 is arranged so all the spacecraft 10 within the constellation follow a common path or skytrack S (see also FIG. 5A) as viewed from the ground. In this manner at least one of the satellites 10 is substantially within the active zone A at all times. Each satellite or spacecraft 10 enters the active zone at essentially equal intervals of time. This is accomplished by placing the satellites 10 in constellation 112 in multiple orbit planes and separating the satellites by an appropriate phase difference along the orbit arc in Mean Anomaly (see FIG. 2A). In addition, another feature of the preferred embodiment allows the satellites 10 to be maneuvered between orbit planes and orbit sub-planes using on-board satellite maneuvering mechanisms. In this manner backup satellites may be placed in orbit with the primary satellites, or in sub-planes between the orbital planes of the active, or primary satellites as will be described further below.

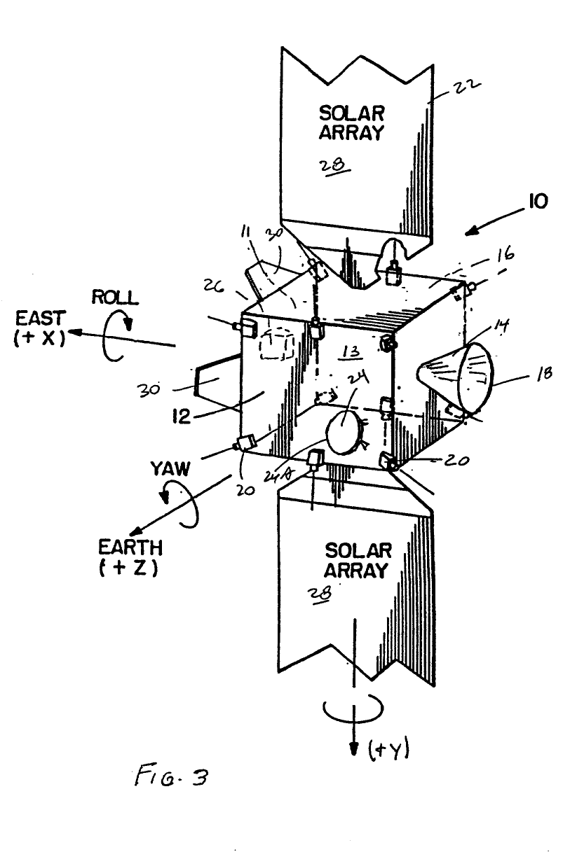

The satellites 10 in constellation 112 are substantially the same. Satellites 210-810 in different orbit planes 02-08 having a different numeral prefix (i.e. 2-8) to identify the satellites in orbit planes 2-8. Referring now to FIG. 3, there is shown a perspective view of an exemplary satellite 10 in constellation 112 shown in FIGS. 2-2A. Satellite 10 is a communication satellite and generally comprises a bus 12, and a communication payload 11, mounted to the bus 12. The spacecraft bus 12 may include a spacecraft maneuvering system 14, and an electrical power system 22. The maneuvering system 14 is used for maneuvering the spacecraft, and for attitude control. The electrical power system 22 provides electrical power to bus 12 and to the payload 11. The spacecraft bus 12 may also include a communication system 24 for communicating ephemeris data with ground station(s) 2 and with other satellites 10 in the constellation 112 or other spacecraft. In particular, still referring to FIG. 2, the spacecraft bus 12 has a frame 13. The maneuvering system 14 of the spacecraft 10 generally comprises at least one main, or maneuvering thruster 18, and attitude thrusters 20 which are mounted to the bus frame 13. The main thruster 18 is sized preferably for delivering sufficient thrust for performing spacecraft orbit raising and lowering maneuvers and to change the orbital plane of the spacecraft 10. The main thruster 18 preferably, uses monopropellant hydrazine (N₂ H₄). The monopropellant hydrazine is stored in suitable tanks (not shown) and is fed to the main thruster 18 using suitable piping and injectors (not shown) housed within the bus 12. The monopropellant hydrazine provides the main thruster 18 with a specific impulse of about 230 seconds and an efficiency of 0.95. In alternate embodiments, the main thruster may be any other suitable type of thruster, such as for example, an electropropulsion thruster, or gas thruster, and may use any suitable type of fuel including for example, solid propellant, bi-propellant fuels, or cold gas. As shown in FIG. 2, the attitude thrusters 20 may be mounted on the bus 12 in thruster strings though the attitude thrusters may be disposed in any other suitable manner. The attitude thrusters 20 are capable of changing the orientation of the spacecraft 10 about the three axes (X,Y,Z) of the spacecraft 10. In the preferred embodiment, the attitude thrusters 20 are cold gas thrusters using pressurized helium (He), although any suitable type of low thrust thruster may be used including electric propulsion thrusters using any suitable type of fuel. The pressurized helium is stored in suitable tanks (not shown) on the bus. The pressurized helium provides the attitude thrusters 20 with a specific impulse of about 160 seconds and an efficiency of about 0.9. In addition to the attitude thrusters 20, the spacecraft 10 may have an attitude stabilization system (not shown) comprising one or more momentum wheels for stabilizing the spacecraft attitude about one or more axis as desired. The operation of the main and attitude thrusters 18, 20 of the spacecraft maneuvering system 14, as a well as the attitude stabilization system if any, is controlled by a controller 26 within the bus 12. Electrical power for the controller operation as well as for the operation of the maneuvering system 14 or the various subsystems (e.g. valves, injectors) supporting operation of the thrusters 18, 20 is provided by the spacecraft's electrical power system 22. In the preferred embodiment, the electrical power system 22 comprises a pair of solar panels 28 which depend from the bus frame. In alternate embodiments, the spacecraft power system may have any suitable number of solar panels disposed on the bus. The power system 22 may also include a suitable number of batteries (not shown) for storing power from the solar panels and powering the spacecraft systems when the solar panels are in shadow. The communication system 24 of the spacecraft 10 allows bi-directional communication between the spacecraft controller 26 and the ground stations. The communication system 24 includes directional, and omni-directional antennas 24 A (only one directional antenna is shown for example purposes in FIG. 2) which are connected by appropriate transmitters and receivers and electrical conduits to the controller 26. By way of example, the controller 26 may thus transmit spacecraft ephemeris data to the ground station(s) 2. The controller 26 may in turn receive programming changes or updates from the ground station(s) 2 for executing satellite housekeeping functions or performing satellite maneuvers.

The communication payload 11 is supported by the bus 12. The payload 11 may be included within the bus frame 13 (as seen in FIG. 3) or may be supported external to the frame. The communication payload 11 preferably includes broadband transceiver 16 and antennas 30 suitable for establishing communication uplinks and downlinks with the base station 2 and ground terminals. In the preferred embodiment, the transceiver 16 is a “bent-pipe” transceiver, which relays data without on-board processing. This reduces the size and complexity of the satellite 10. In alternate embodiments, the satellite may have any suitable type of transceiver. The antennas 30 are electronically connected to the transceiver and pre shown for example as being directional antennas which may be gimbaled as desired. Omni-directional antennas may also be provided.

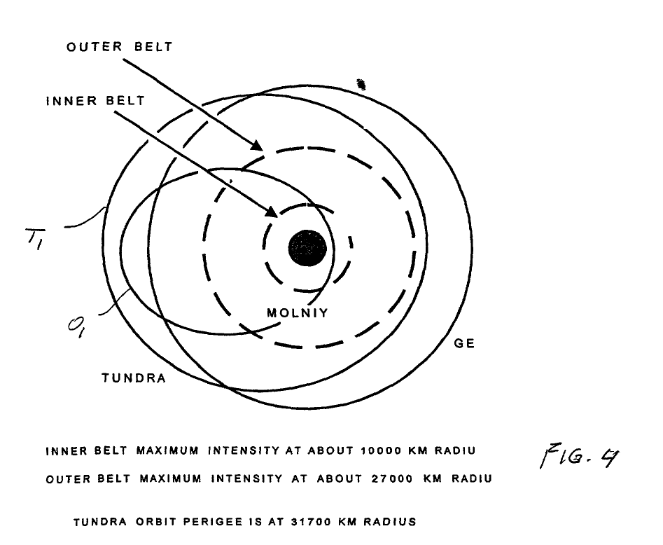

Referring now again to FIGS. 2-2A, there is shown a high-inclination orbit (e.g. Tundra or Molniya orbits), spacecraft constellation 112 (FIG. 2A illustrates satellites in constellation 112 in Molniya orbit), supporting broadband or high-data rate communications between ground terminals 1 and base stations 2 of the communication system 110. The Tundra and Molniya orbits of the satellites in the constellation 112 are advantageous to the operation of the communication system. For example, a single Tundra orbit spacecraft can be viewed within a wider zone of longitude in the northern temperate zone than a GEO spacecraft, making it possible to link cities as far apart as Tokyo and New York with a single hop, which is not possible for a GEO spacecraft. As seen in FIG. 2A, the communication system 110 in the preferred embodiment employs a constellation 112 comprising eight (8) satellites, although the present invention is equally applicable to communication systems employing a constellation of as few as three (3) satellites. The satellites 10-810 in constellation 112 seen in FIG. 2A are depicted in Molniya orbits, though as noted above, the satellites of the constellation may also be in Tundra orbits (the schematic representation in FIG. 2 is meant to cover either Tundra or Molniya orbits). FIG. 4 shows a representative Molniya orbit 01, a representative Tundra orbit T1 and a geosynchronous orbit G1 for comparison purposes (all orbits are shown in the same plane). The Tundra T1 and geo G1 orbits do not enter the maximum intensity region of the outer Van Allen Belt and avoid the inner belt entirely. The Molniya orbit O1 traverses both belts. Table 1 below lists characteristics of the satellite constellation 112 in the case of both Tundra orbit and Molniya orbit. In addition, Table 1 also lists characteristics for conventional satellite constellation in geosynchronous orbit for comparison purposes.

TABLE 1
Tundra Orbit Comparison with Molniya and
Geosynchronous Orbits For 8-spacecraft Constellation

| Orbit Type | Tundra | Molniya | Geosynchronous |
|---|---|---|---|
| Orbital Period | 24 | 12 | 24 |
| (hr) | | | |
| Semi-major axis | 42164 | 26561 | 42164 |
| (km) | | | |
| Eccentricity | 0.268 | 0.72 | 0.0 |
| Inclination (deg) | 40-70 | 63.4* | 0.0 |
| | (typically) | | |
| Right Ascension | X, X + 45, X + 90, | X, X + 45, | Typically |
| of | X + 135, X + 180, | X + 90, | about 90 or |
| Ascending Node | X + 225, X = 270, | X + 135, | 270 |
| (deg) | X + 135 | X + 180, | |
| | | X + 225, | |
| | | X + 270, | |
| | | X + 315 | |
| Argument of | 270 | 270 | — |
| perigee | | | |
| (deg) | | | |
| Mean Anomaly at | Y, Y − 45, Y − 90, | Y, Y − 90, | — |
| Epoch (deg) | Y − 135, Y − 180, | Y − 180, | |
| | Y − 225, Y − 270, | Y − 270, Y, | |
| | Y − 315 | Y −90, | |
| | | Y − 180, | |
| | | Y − 270 | |
| Walker Pattern* * | 8/8/7 | 8/8/6 | — |
| Apogee radius | 53481 | 45744 | 42164 |
| (km) | | | |
| Apogee altitude | 47100 | 39366 | 35786 |
| (km) | | | |
| Perigee radius | 80847 | 7378 | 42164 |
| (km) | | | |
| Perigee altitude | 24500 | 1000 | 35786 |
| (km) | | | |

*Inclination must be set to 63.4° for the 12-hour Molniya orbit to prevent argument of perigee variation.
**Layout of each constellation is a Walker pattern of the form T/P/F = N/N/N-Q, where T is the total number of spacecraft, P is the number of orbit planes, F is the phase difference between corresponding spacecraft in adjacent planes, and Q is the number of orbital revolutions completed each day and is an integer.

As can be realized from FIG. 4, and Table 1, the Molniya orbit has a period of 12 hours (half of a side real day). The orbit is highly eccentric with an eccentricity of 0.72 and has a semi-major axis of 26561 KM. Thus, maximum loiter time of the satellite is in proximity of the apogee. The orbital inclinations is 63.4°, the so called “critical inclination”, which prevents apsidal rotation or variation in the argument of perigee (ARGP) due to terrestrial oblateness. FIG. 4A depicts a representative ground track G for a satellite in a Molniya orbit. In the case depicted in FIG. 1, the Molniya orbit of the satellite is positioned so that the location of the first and second apogees over the ground each day are at about 10° Lon., and 190° Lon. respectively. The right ascension of the ascending node (RAAN) of the satellite orbit may be varied so that the first and second apogees per day for the satellites 10-810 in constellation 112 may be located as desired. As noted before, the Molniya orbits of satellites 10-810 are disposed so that the satellites follow a substantially common ground, similarly to track G in FIG. 4a, and hence when viewed from the ground, would follow a substantially common skytrack. Table 1 indicates each of the satellites 10-810 in eight satellite constellation 112 orbits in a different orbit plane. This is shown in FIG. 2A, which illustrates orbit paths O1-O8 of the satellite constellation. The right ascension of the ascending node (RAAN) of the orbit planes are separated by 45°. In addition, the eight satellites 10-810 in the constellation are distributed in a Walker pattern as noted in Table 1. The Walker pattern has the form T/P/F=N/N/N−Q. The symbol T stands for the total number of satellites which in the preferred embodiment is eight (8) (i.e. T=N=8). The symbol P stands for the number of orbit planes of the constellation which in the preferred embodiment is thus also eight (8) (i.e. P=N=8). The symbol F stands for the phase difference between corresponding satellites in adjacent planes, and satisfies the relation F=N−Q where Q is the number of orbital revolutions completed each day and is an integer. Thus, in the case of the Molniya orbit Q is two (2), which leads to the result F=6. Phase difference F is along the arc of the orbit in Mean Anomaly. The phase difference F is measured in pattern units (PU), of which one PU is 360° divided by the total number of spacecraft, or PU=360°/N. The Walker constellation pattern of the form T/P/F=N/N/N−Q constrain all satellites 10-810 within the constellation 112 to follow a common ground track (similar to that shown in FIG. 4A) that repeats once each day. Correspondingly, when viewed from the ground the satellites 10-810 in the constellation 112 also follow a common skytrack with each satellite entering the active zone A, at location P1 in proximity of the apogee, at substantially equal periods of time.

Table 1 also identifies the constellation parameters in the case where the satellites 10 in the constellation are in the 24-hour Tundra orbit, which is displayed in FIG. 4. Semi-major axis for the Tundra orbit is 42164 km so that the spacecraft completes one revolution every sidereal day, just as in a GEO spacecraft. However, orbital inclination is typically in the range of 40° to 70°. Eccentricity is increased, but only to 0.268 to improve apogee loiter time while avoiding lowering perigee into the Van Allen Belts. Argument of perigee (ARGP) is set to 270° to put the apogee region at the maximum northerly latitude. These conditions optimize coverage for the northern temperate zone. The Tundra orbit constellation is also placed in a Walker pattern which, in the case of the eight satellite constellation of the preferred embodiment, has the form 8/8/6. The phase difference along the arc of the orbit in Mean Anomaly is 90° in this case. As noted before, the Walker pattern of the form T/P/F constrains all satellites within the constellation to follow a common ground track that repeats once each day. This allows the active zone A to be set at the region of maximum satellite loiter with respect to a given position on the ground (see FIGS. 1, and 5A).

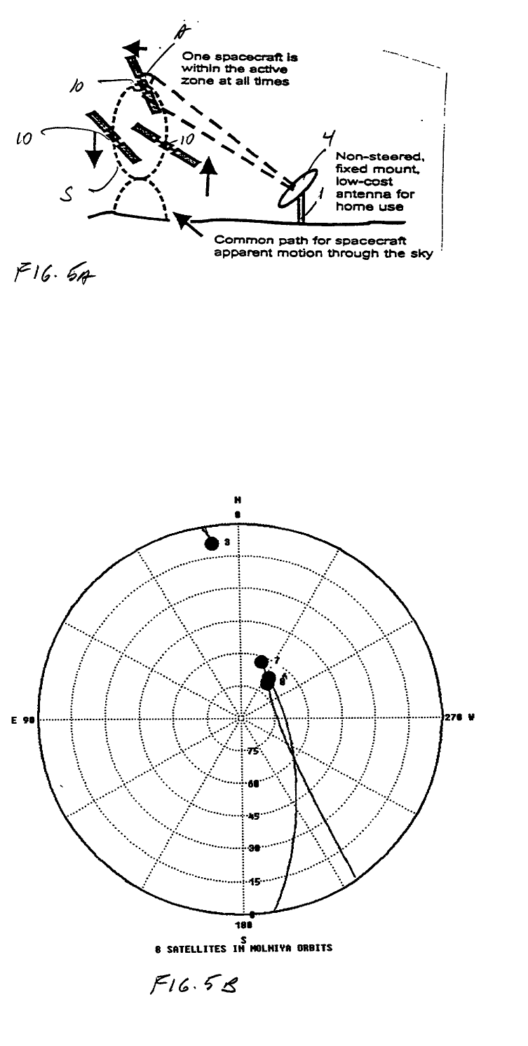

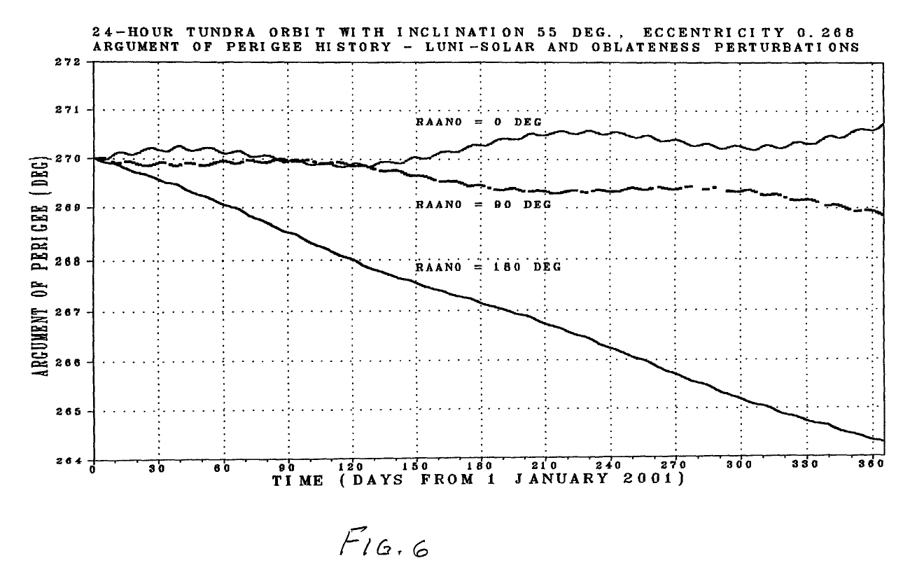

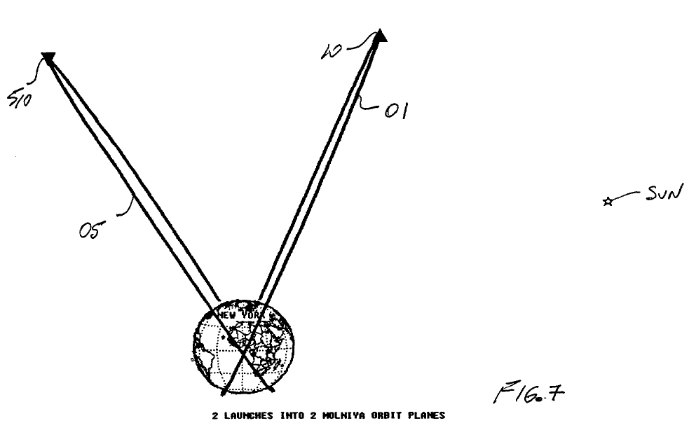

Due to the high altitude of the Tundra orbit the inclination need not be set to the so-called “critical inclination” of 63.4° to neutralize apsidal rotation or variation in ARGP due to terrestrial oblateness. This effect is weaker for higher orbits, and luni solar gravitational perturbations are dominant. FIG. 6 graphically depicts the variation in the ARGP of the Tundra orbit. The magnitude and polarity of ARGP variation for the Tundra orbit with a representative inclination of 55° is highly dependent upon the value of RAAN, due to luni-solar perturbations. Terrestrial oblateness perturbations cause ARGP to monotonically increase for an orbit of this inclination. However, the luni-solar perturbations dominate except for where RAAN value is in the general vicinity of 0°. Therefore, it is not important to null out variations in ARGP due to terrestrial effects for the Tundra orbit and the inclination of the Tundra orbit need not be constrained to 63.4°. As can be realized from FIG. 6, variation in ARGP can be corrected with the satellite maneuvering system 14 (see FIG. 3) using a modest amount of propellant in orbit keeping maneuvers. Total annual velocity increment (ΔV) for all orbit keeping maneuvers is nearly the same as that for GEO, in the neighborhood of 50 m/s per year.

Orbit keeping annual velocity increment (ΔV) can be minimized using a combination of techniques suitable for use in constellation 112 with satellites in inclined orbits such as the Tundra and Molniya orbits. These techniques are not applicable to geosynchronous near-zero inclination spacecraft which operate individually and do not have any sizable relative motion with respect to ground users. A first technique deadbands on certain orbital elements. Such orbital elements include for example, orbital inclination and RAAN value. In the case of these elements, the deadbands can be made sufficiently wide so that natural effects that operate to alternately increase and decrease the value of these elements over a span of years may be permitted to run their course. This minimizes station keeping maneuvers conducted by the satellites in constellation 112 (whether in Tundra or Molniya orbits) again reducing the propellant consumed by the satellite and providing a commensurate increase in the life span of the satellite.

In accordance with an aspect of the preferred embodiment, a second technique for station keeping satellites in constellation 112 uses certain orbital elements which are relative easy to modify through maneuvers in order to compensate for the effects in the variation of another orbital element that is less easily modified. By way of example, the Mean Anomaly at epoch may be modified in order to compensate for variation in RAAN. The satellite maneuvering system 14 (see FIG. 3) may be operated as desired to increase or decrease the Mean Anomaly at epoch thereby modifying the skytrack for the orbit to compensate for the change to the skytrack induced by the change in RAAN, and preserving the capability of the satellite to pass through the same active zone as viewed from the ground. The satellite maneuvering system 14 may use a small quantity of propellant to achieve a small change in the Mean Anomaly at epoch which performed at the desired location in the orbit effects the desired change in RAAN in the satellite orbit. In this manner the RAAN value of the orbit of any of the satellites 10-810 in constellation 112 may be changed as desired. By comparison, the conventional approach of changing the RAAN the desired amount by directly using the maneuvering system of the satellite to effect the RAAN change consumes a much larger quantity of propellant.

Still in accordance with an aspect of the preferred embodiment, a third technique for station keeping satellites 10-810 in constellation 112 employs a minor modification of one orbital element through modest maneuvers to indirectly control the variation of a second element that would require sizable maneuvers to control directly. For example, a modest modification of orbital inclination can cause a large salutary modification of ARGP. The satellite maneuvering system 14 may be operated, such as by firing the main thruster in a direction normal to the orbital plane, at locations near where the satellite orbit crosses the plane of the equator to increase or decrease the inclination of the orbital plane. A change of about 0.4° in the inclination of the satellite orbit, especially in the case of the Molniya orbit from about 63.4°, brings about apsidal precession in the satellite orbit and change in the ARGP. In the case of the Molniya orbit, the inclination can return to a value nearer the initial value of 63.4° without use of the maneuvering system. The amount or propellant used by the maneuvering system to change the inclination about 0.4° is much less than the amount which would have to be used to directly change the ARGP. Over the extensive span of time that the value of ARGP is controlled by modifying inclination.

Still yet in accordance with an aspect of the preferred embodiment, a fourth technique for minimizing annual orbit keeping maneuvers sets initial values of orbital elements at the beginning of the mission lifetime to different values for the various satellites in the constellation. These initial orbital values may be set by the launch vehicles that inject the satellites 10-810 into orbit. Otherwise, the initial orbital values of the satellites may be established by orbital injection maneuvers performed shortly after launch using the maneuvering system 14 of the satellite. FIG. 7 shows two representative Molniya orbits O1, O5 for satellites 10, and 510 in constellation 112 (see also FIG. 2A). The orbital plane of orbit O1 has an initial RAAN equal to 0°, and the orbital plane of orbit O5 has an initial RAAN equal to 180°. The satellites 10, and 510 are shown at or near apogee for example purposes only. The inclination of orbit O5 is smaller than the inclination of orbit O1. For example, the inclination of orbit O1 may be about 63.4°, and the inclination of orbit O5 may be about 63.0°, although in alternate embodiments the orbital planes may have any desired orbital inclination. Orbital perturbations due to the moon and sun (shown as the star in FIG. 7) do not affect the position of apogee over time for the orbit plane having RAAN of 0°. There is however a significant affect for the orbit plane having a RAAN of 180°. The reason for this is that the orbit plane with a RAAN of 180° is nearly perpendicular to the plane of motion of the sun and moon (extending through the earth and star in FIG. 7). To compensate for this effect upon apogee, the inclination of the orbit plane with RAAN of 180° is reduced initially (to 63.0° as noted above for example) which causes a perturbation (apsidal precession) due to terrestrial gravity to oppose the perturbation due to the moon and the sun. Attitude control of the satellites in constellation 112 may be performed using maneuvering system 14 in the manner disclosed in U.S. Pat. No. 6,318,676 which is incorporated by reference herein in its entirety.

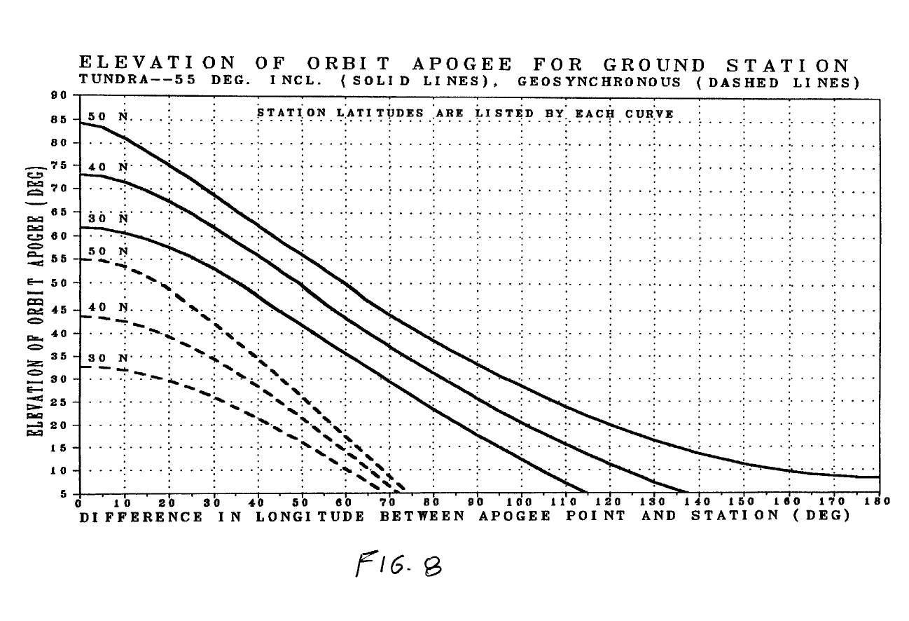

FIG. 8 is a graph that illustrates the advantage of a satellite in Tundra orbit such as in the preferred embodiment over a GEO spacecraft for connecting distant points in the northern temperate zone with a single hop. Elevation from Tundra orbit apogee comfortably exceeds that from the traditional GEO spacecraft for all comparable cases and virtually eliminates the need for double hops involving two spacecraft, or for a landline for a portion of the link between many pairs of cities. Near apogee the Tundra orbit outperforms GEO spacecraft. For ground terminals or base stations in Tokyo and London, which are about 140° of longitude apart, a GEO spacecraft midway between the two in longitude can be observed from both cities at an elevation of about 5°, whereas the Tundra orbit spacecraft can view both cities at elevations exceeding 35°. For ground terminals or base stations Tokyo and New York, which are separated by 146° in longitude, a single GEO spacecraft cannot be observed from both cities. However, a Tundra spacecraft near apogee can be observed from both cities at elevations exceeding 30° if the spacecraft is midway between them.

FIG. 9 is a pictorial view of the ground as seen from a point near the apogee of a Tundra satellite in constellation 112 positioned above the north Pacific. For example, the apogee is at 160° W. longitude, with the satellite in a position 90 minutes after apogee crossing (the time at which the satellite in the 8-unit constellation 112 would conclude its active time span and hand-off to a sister satellite). Elevations for the most distant ground sites are at minimum at this point within the active time span. As can be seen in FIG. 9, virtually the entire northern Pacific Rim, all of the United States, Canada, Japan, most of China, and certain busy areas in Europe are visible. In the case shown, an observer in Tokyo can view the spacecraft at an elevation exceeding 35° and a New York observer can view the spacecraft at an elevation exceeding 25°.

The example orbit condition displayed in FIG. 9 shows the satellite remaining in view of South Point, Hawaii for its entire revolution, with minimum elevation of about 4° occurring near perigee with the satellite low in the southern sky. South Point looks out over the open ocean to the south. There are already numerous antennas at this location to communicate with spacecraft. The ability to communicate with the spacecraft from a control station at all times simplifies the spacecraft design and is advantageous for mission operations, retaining some of the positive characteristics of GEO spacecraft.

Table 2 below lists the operational characteristics for satellites in constellation 112 having a Tundra or Molniya orbit as well as for satellites in a conventional geosynchronous orbit.

TABLE 2
Comparison of Operational Characteristics of
Orbit Types

| Orbit Type | Tundra | Molniya | GEO |
|---|---|---|---|
| Orbital Period (hr) | 24 | 12 | 24 |
| Time span over which customer | 3 | 3 | 24 |
| service is provided | (Apogee | (Apogee | |
| | +/−1.5) +/− | | |
| | | 1.5) | |
| Number of non-redundant | 8 | 8 | 1 |
| spacecraft required to provide | | | |
| optimal coverage | | | |
| Apogee radius (km) | 53481 | 45744 | 42164 |
| Apogee altitude (km) | 47100 | 39366 | 35786 |
| Minimum radius when providing | 53000 | 37320 | 42164 |
| service to ground users, 8-unit | | | |
| constellation (km) | | | |
| Minimum radius when providing | 46600 | 30940 | 35786 |
| service to ground users, 8-unit | | | |
| constellation (km) | | | |
| Pedigree radius (km) | 30847 | 7378 | 42164 |
| Pedigree altitude (km) | 24500 | 1000 | 35786 |
| Change in size of area | 1.02 | 1.25 | 1.0 |
| illuminated by a constant-width | | | (no |
| antenna beam during coverage | | | zoom) |
| region of orbit (zoom factor) | | | |
| Range rate (m/s) during coverage | +/−190 | +/−770 | 0 |
| region of orbit | | | |
| Single station can view | Yes | No | Yes |
| spacecraft during entire orbital | | | |
| revolution? | | | |
| Typical perigee outage duration | 0 | 70 | 0 |
| for ground station network (min) | | | |
| Maximum eclipse duration (min) | 80 | 60 | 72 |
| Can eclipse occur when the | No | No | Yes |
| spacecraft is providing coverage? | | | |

FIG. 5B is a 360° fish-eye view from the ground at an exemplary location such as location A (New York City) in FIG. 1. The positions of satellites 310, 610, 710, 810 visible in FIG. 5B, which are in Molniya orbits, corresponds to the positions shown in FIG. 2A. FIG. 5B shows that many of the satellites 310, 610, 710, 810 cluster in a relatively small region of the sky that corresponds to the active zone A (see FIG. 1) for the antenna 4 of the ground terminal (see also FIG. 5A). All satellites 310, 610, 710, 810 follow common skytrack S.

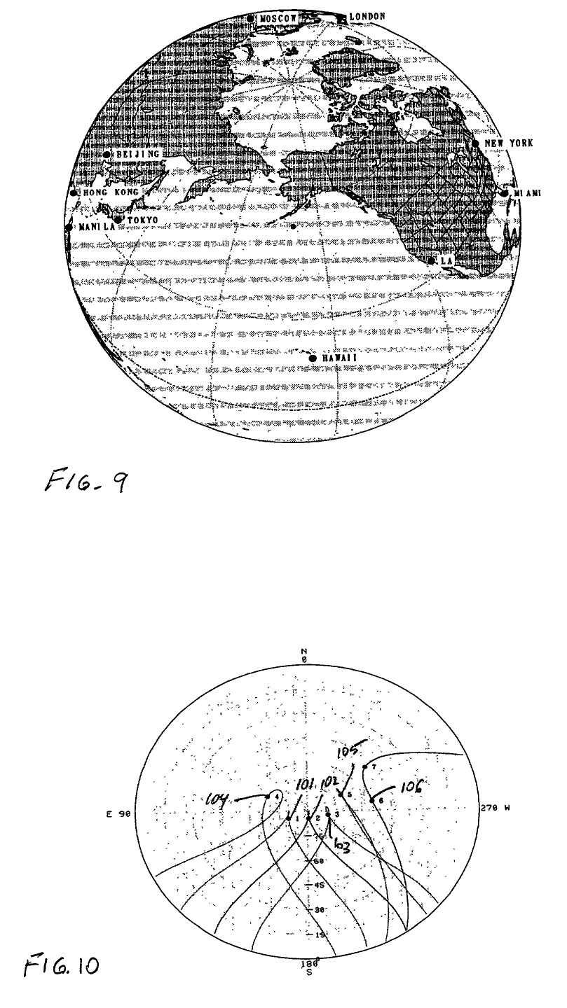

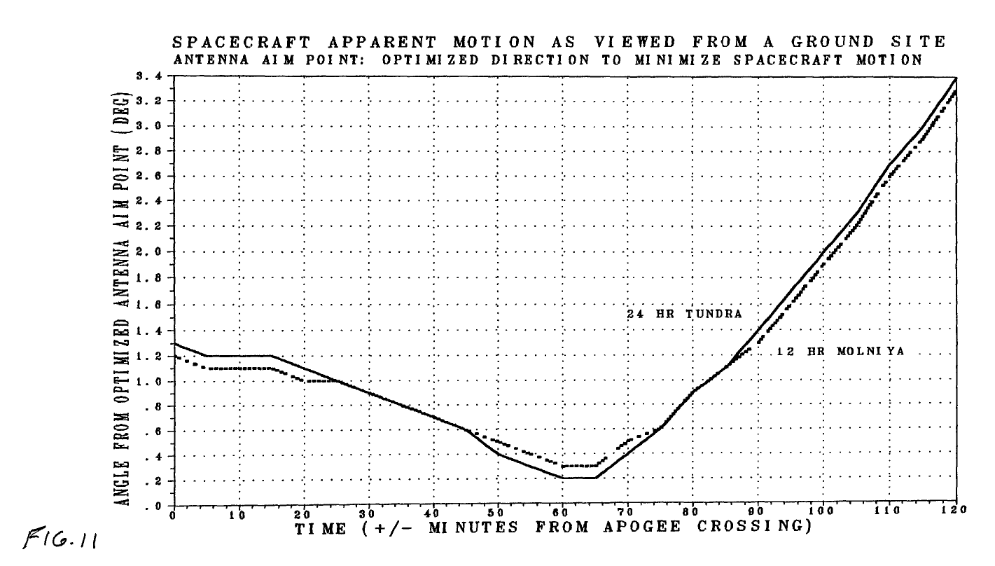

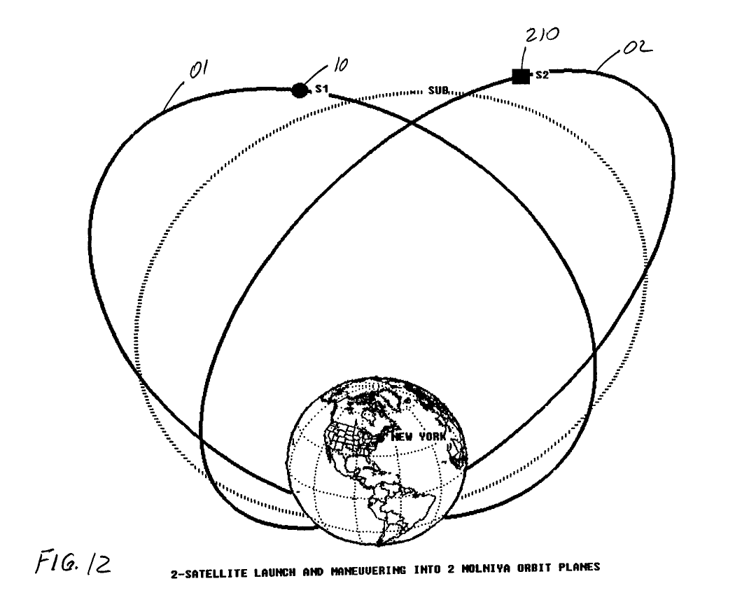

FIGS. 10, and 11, show that the 55°-inclined Tundra orbit is similar with the Molniya orbit in its ability to maintain a spacecraft within a very small region high in the northern sky for a 3-hour window of time centered on the apogee crossing. In either orbit case, the small, narrow-beam, broadband, low-cost antenna 4 on ground terminals 1 can operate with the constellation 112 of only 8 satellites. FIG. 10 displays the apparent motion of spacecraft from a number of candidate orbits as viewed from a ground site similar to sites B,C,D in FIG. 1. Satellites 101, 102, 103, and 104 are in a 24-hour Tundra orbit with inclinations of 54°, 55°, 56°, and 63.4°, respectively. Spacecraft 105 is in a 12-hour Molniya orbit with inclination 63.4°. Spacecraft 106 is in an 8-hour orbit with inclination 63.4° for comparative purposes. The positions of the various spacecraft are shown 2 hours after apogee crossing. Apogee crossings for spacecraft 101-105 occur at the head of each curve. Apogee crossing for spacecraft 106 occurs at the point marked “7”. Spacecraft 102, in 24-hour Tundra orbit with 55° inclination, and spacecraft 105, in the 12-hour Molniya orbit, have the smallest apparent motion during a span of time from apogee to 2 hours after apogee. In both cases the spacecraft essentially passes twice through the same point in the sky during the segment of its orbit where it is providing coverage to users on the ground. The Tundra orbits with inclination near 55° and the Molniya orbit provide a window of time of three hours centered on apogee crossing where the spacecraft remains within an angle of 1.3° from an optimal antenna aim point. With this 3-hour coverage window, a constellation of eight spacecraft would provide coverage 24 hours a day.

FIG. 11 displays the apparent angle between an optimal antenna aim point and a spacecraft in the 12-hour Molniya, and a spacecraft in a 24-hour Tundra orbit with inclination 55° for a window of three hours centered on apogee both spacecraft remain within 1.3° of the aim point. The antenna aim point was optimized to minimize the angle between the reference direction and the spacecraft, as viewed from a ground site, for the entire time span beginning 90 minutes prior to apogee crossing and ending 90 minutes after apogee crossing In alternate embodiments, a narrow field of view, non-steerable, low-cost antenna could be employed to work with spacecraft in either orbit case.

The orbit of the satellites in constellation 112 advantageously minimizes spacecraft range rate with respect to the location of the ground terminals 1 and base station 2 (B,C,D see FIG. 1) during the active region of the orbit. This minimizes Doppler shift correction for communications. For the Tundra orbit, range rate varies from +190 to −190 m/s over a three-hour time span centered on apogee. However, range rate varies from −770 m/s to +770 m/s for the Molniya orbit, therefore Doppler shift for a given frequency will be four times greater. For a Kₐ-band signal at 30 GHz frequency observed on the ground varies by +/−19 kHz for the Tundra orbit and by +/−77 kHz for the Molniya orbit.

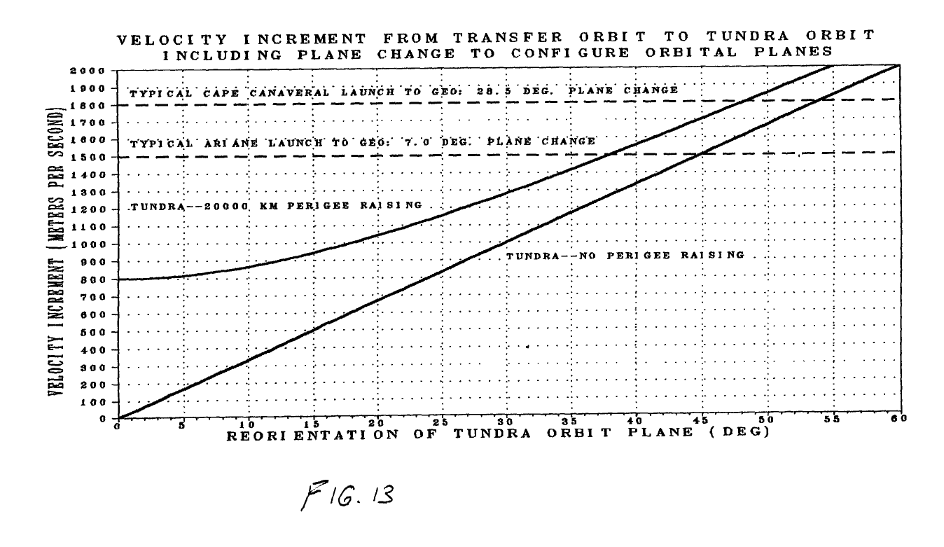

The satellites in constellation 112 may be launched preferably two or more at a time using a common launcher. This is shown in FIG. 12 for satellites 10, 210 which as depicted in FIG. 2A are injected into Molniya orbits. Launching the satellites in the constellation two or more at a time may be accomplished equally well for satellites to be placed into Tundra orbits. As can be recognized from FIG. 12, the satellites 10, 210 most suitable for launch on a common launcher are destined for orbits in adjacent orbit planes in the constellation. In addition, spare satellites (not shown), available in case of failure of a primary satellite, may also be launched on the same launcher as satellites 10, 210. The launcher places satellites 10, 210 into an orbit plane SUB which is a sub-plane of the operating orbit planes O1, O2 of the satellites 10, 210. As seen in FIG. 12, the sub-plane SUB is preferably positioned between the operating orbit planes O1, O2. For example, in the case operating orbit plane O1 has a RAAN of 0°, and orbit plane O2 has a RAAN of 45°, the sub-plane SUB into which the launcher injects both satellites 10, 210 as well as any spares has a RAAN of 22.5°. After the satellites 10, 210 are injected into orbit in sub-plane SUB, the satellites 10, 210 may be maneuvered using the launcher (not shown) or the satellite maneuvering system 14 (see FIG. 3) to change the orbit plane from the orientation of the sub-plane SUB to the respective orientations of the corresponding operating orbit planes O1, O2. For example, the maneuvering system of satellite 10, may be fired as desired (such as at positions near the apogee and perigee of its orbit in sub-plane SUB) to alter the RAAN of its orbit plane 22.5° to the East of the sub-plane SUB thereby placing the satellite 10 in orbit plane O1. Similar by opposite, the satellite 210 is maneuvered to alter the RAAN of its orbit plane 22.5° to the west thereby placing the satellite 210 in orbit plane O2. A velocity increment of about 800 m/s would be used to alter the RAAN of the orbit plane about 22.5°. The spare satellites may be allowed to remain in the sub-plane SUB with the phase difference appropriately adjusted to allow the satellite to commence operation from the sub-plane SUB. This launch approach minimizes the fuel used to inject the satellites of constellation 112 into the operating orbits. The above process may be repeated for all the satellites in the constellation 112. Hence, the constellation 112 of the preferred embodiment may be placed in orbit with as few as four launches.

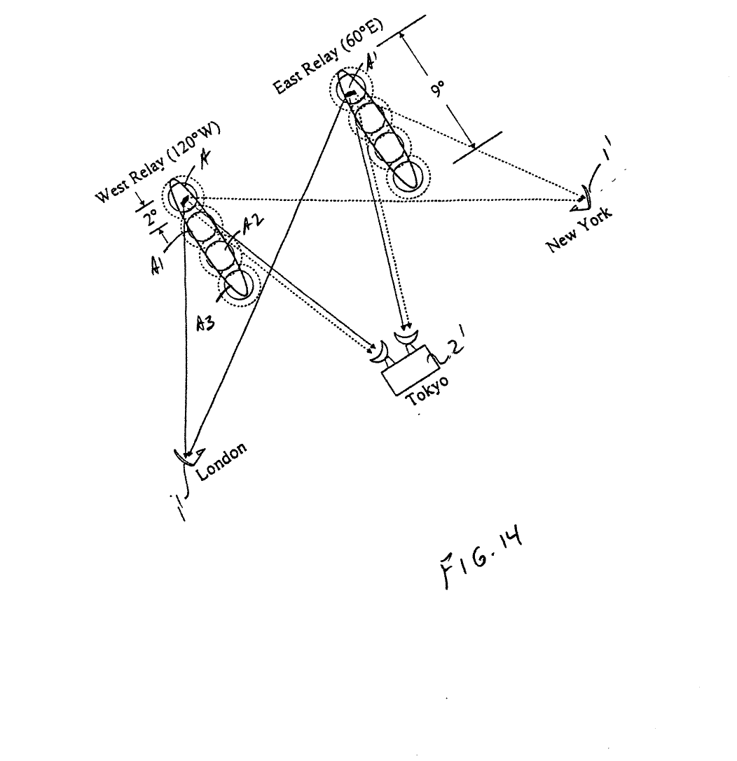

To establish spacecraft in a Tundra orbit constellation, launch vehicles (LV) with payload capabilities of several tons to geosynchronous transfer orbit (GTO) will suffice, such as Atlas V., Ariane V, Delta IV, Proton, or SeaLaunch. Transfer from an initial orbit established by the LV to Tundra orbit requires a smaller ΔV than GEO orbit raising, even if a significant plane change is effected (FIG. 13). The satellites in the constellation 112 (similar to satellite 10 in FIG. 3) are sufficiently small in size and mass so that LV volume and mass constraints are not violated. As in the Molniya orbit case described before, in the dual-launch Tundra orbit case, the LV would also be targeted to an initial orbit plane midway in-between two operational orbit planes for the 8-spacecraft constellation. The spacecraft would rotate their orbital planes by 22.5° in opposite directions; thus establishing two orbit planes separated by 45°. As FIG. 7 shows, this would require a ΔV of 700 m/s to 1100 m/s depending upon the case studied, which is considerably less than the minimum orbit raising ΔV of 1500 m/s from a standard GTO to geosynchronous orbit. Each spacecraft undertakes maneuvers involving a total delta V of 750 m/s when no perigee raising is involved and 1100 m/s when perigee raising by 20000 km is involved. Orbit raising can include modification of the right ascension of the ascending node (RAAN) of the orbit plane. This ΔV is supplied by the spacecraft maneuvering system 14. In a scenario involving 4 dual launches to 8 orbit planes a total spacecraft ΔV smaller than that required for GEO orbit raising is involved.

Establishing a fixed active zone allows a ground terminals 1 to direct a communications antenna 4 to a single area (active zone A) where at least one of the satellites within the constellation 112 is on station in the predetermined active zone of the satellite's orbit plane. As one satellite moves out of the active zone, another satellite enters the zone. In this manner the active zone a is continuously occupied by at least one orbiting satellite.

FIG. 14 illustrates how communication system 110′, which substantially the same as system 110 described before with reference FIG. 1, and having a constellation in Molniya orbit provides path diversity for ground terminals 1′. Path diversity is depicted to illustrate the use of two different active zones A, A′; where the satellite in each zone provides the identical signal to the user to overcome atmospheric effects such as rain fade. Four circular coverage areas are shown at each active zone A, A′ to illustrate that a single antenna 4′ containing a switchable feed network can point to any selected spot of the four circular coverage areas to compensate for loss of one or more satellites from the eight satellite constellation. A feature of the two zones with a near simultaneous view of a selected portion of a hemisphere allows bandwidth resources to shared. Another feature of the invention allows the use of smaller and more efficient satellites than comparable satellites used in geostationary orbits. A total of eight satellites in the Tundra and Molniya orbits as described in Table 1provide a versatile and robust constellation that can withstand major failures before impact to communications service occurs. Four satellites are sufficient to provide full service. The four additional satellites provide capacity enhancement and flexibility as well as system redundancy.

In addition, another feature of the preferred embodiment is the high elevation of the active zone to an observer at middle northern latitudes. This permits the users located in the selected portion of the Northern Hemisphere antenna to point northerly and with a higher vertical elevation instead of pointing south towards the equatorial orbit plane and a lower elevation as with GEO systems. The higher vertical elevation permits the signal to travel through less of the atmosphere and thus be subject to less environmental degradation as well as signal interference due to physical obstructions. Also, since the active zone is well above or below the equatorial plane the threat of signal interference due to satellite congestion is reduced. Another feature of the preferred embodiment is the capacity for uninterrupted service due to the backup satellites. The location of the active zone is within a 20° segment of the atmosphere at a constant longitude that is 9° wide. When all eight satellites are in place, the user points a 2° circular beam to one location within the 9° wide portion of the active zone. A switchable feed in the user antenna adjusts the beam along the 9° width to automatically support backup operations. It will be readily appreciated that in alternate embodiments that the polar orbits of the satellites are adjustable so that a designated satellite's orbit could be adjusted to compensate for a failed satellite. Another feature of the invention allows communication connection of points that are too far apart in longitude for a satellite in a geosynchronous equatorial orbit to connect.

Another embodiment of the subject invention can provide broadband service to multiple geographical regions in the Northern Hemisphere. Regions of interest are North America, Europe, and East Asia. Three separate constellations of multiple Tundra orbit spacecraft would each be dedicated to one of these regions. Each constellation would provide primary service from spacecraft at high elevation, on the order of 40° or higher, for its designated primary region; and secondary service to the other regions at low elevation, typically below 20°. All three constellations would use orbits at a common orbital inclination, which would be expected to be about 55° for the Tundra orbit and 63.4° for the Molniya orbit.

Each constellation would involve a multiple orbital planes, with one plane for each active spacecraft in the constellation. The three constellations, however, share common orbital planes; i.e. the right ascension of the ascending node of the orbit is the same. Therefore, each orbital plane includes three active spacecraft, one each for the North America, Europe, and East Asia constellations. Satellites can be easily moved from one constellation to another by being repositioned within its orbital plane, which would involve a total delta-V on the order of 10 meters per second, instead of hundreds of meters per second for an orbital plane change. The time span for this repositioning would be on the order of one month or less.

A launch involving a plurality of satellites, such as, for example, a dual launch on a single launch vehicle, can supply satellites to more than one of the three constellations discussed in this example. Launch risk and cost can thus be shared between constellation owners. Spare satellites can serve to replace units in any of the three constellations. The spare satellite could be injected into an active plane, in a case where multiple constellations are involved this spare could replace one active member of each constellation. Since this is an in-plane maneuver of the spare, total delta-V would be on the order of 10 meters per second and time span to move into position would be on the order of a month or less. The spare could also be injected into a sub-plane mid-way between two active planes and be capable of replacing two active members of each constellation. Total delta-V for repositioning would be about 400 meters per second in the case where the constellations include 8 orbit planes separated by equal intervals of right ascension of ascending node of 45°.

The features of the present invention include a broadband communications satellite system involving a plurality of satellites in orbits substantially inclined to the equatorial plane; the orbits having a common inclination to the equatorial plane. The substantially regularly-spaced satellite orbit planes are in sufficiently close proximity in right ascension of ascending node that a plurality of satellites carried on a single launch vehicle can be injected into the orbital planes using a modest delta-V on the order of 1100 meters per second or less, in a modest amount of time, corresponding to two weeks or less.

In an alternate embodiment, the broadband communications satellite system comprises a plurality of inclined orbital planes in which spare satellite units can be positioned. The orbital planes containing the spare satellites are separated by a sufficiently small difference in right ascension of ascending node from the planes containing the active satellite units; such that any single spare satellite can replace an active satellite using a modest delta-V of about 700 meters per second or less.

In another embodiment the invention provides a broadband communications satellite system having at least two satellites or constellations. The broadband communications system provides optimal high-elevation coverage to a specific geographical region while the constellations share common orbit planes with substantially the same inclination to the equator and sufficiently close proximity in right ascension of ascending node so that satellites can be moved from one system or constellation to another without altering the orientation of its orbit plane in space. Thus satellite repositioning is enabled with a very modest delta-V of about 10 meters per second. In addition, the satellites may be launched on a common launch vehicle and can be injected into the broadband communications system with modest delta-V of 1100 meters per second or less.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A broadband communication system comprising:
a first broadband communication ground station;
a second broadband communication ground station; and
a satellite constellation for conducting bi-directional broadband communication between the first broadband communication ground station and the second broadband communication ground station, at least one satellite of the satellite constellation having an inclined eccentric orbit in a first orbit plane;
wherein the satellite constellation is disposed in orbit so that when observed from a predetermined ground observation point a number of satellites, including the at least one satellite, in the satellite constellation appear to follow a substantially common path which extends through a predetermined active zone, the number of satellites moving along the common path so that the predetermined active zone has one satellite from the number of satellites continuously located therein; and
wherein the at least one satellite and at least another satellite from the number of satellites are launched into a common initial orbit plane which is different than the first orbit plane.

2. The system as in claim 1, wherein the predetermined active zone is substantially fixed relative to the first broadband communication ground station, and the ground station has an antenna pointed at the predetermined active zone.

3. The system as in claim 1, wherein the first broadband communication ground station is located at the predetermined ground observation point.

4. The system as in claim 1, wherein the at least one satellite is maneuvered from the initial orbit plane to orbit in the first orbit plane.

5. The system as in claim 1, wherein each satellite in the number of satellites has a different orbit plane, the different orbit planes being arranged to provide an optimal distribution of the number of satellites so that the number of satellites follow the substantially common path with one satellite from the number of satellites always being in the predetermined active zone.

6. The system as in claim 1, wherein the at least one satellite is maneuvered by rotating an orbit plane of the at least one satellite from an initial orientation corresponding to the initial orbit plane to a first orientation corresponding to the first orbit plane.

7. The system as in claim 1, wherein the orbit of the at least one satellite has an eccentricity value of about 0.268.

8. The system as in claim 1, wherein the orbit of the at least one satellite has an eccentricity value of about 0.72.

9. The system as in claim 1, wherein the orbit of the at least one satellite has an inclination between about 40° to 70°.

10. The system as in claim 1, wherein the orbit of the at least one satellite has an inclination of about 63.4°.

11. The system as in claim 1, wherein the orbit of the at least one satellite has an apogee of about 47100 km.

12. The system as in claim 1, wherein the orbit of the at least one satellite has an apogee of about 39366 km.

13. The system as in claim 1, wherein the orbit of the at least one satellite has a perigee of about 24500 km.

14. The system as in claim 1, wherein the orbit of the at least one satellite has a perigee of about 1000 km.

15. The system as in claim 1, wherein the orbit of the at least one satellite has an argument of perigee of 270°

16. The system as in claim 1, wherein the predetermined active zone comprises an arc of about 3° centered on an apogee of the orbit of the at least one satellite.

17. A broadband communications satellite system as in claim 16 wherein the predetermined active zone is viewable from the northern hemisphere at an elevation angle equal to or exceeding 25°.
